(19) United States
(12) Patent Application Publication
(10) Pub. No.: US 2026/0215406 A1
(43) Pub. Date: Jul. 30, 2026

(54) FISHING ROD REEL SEAT, AND FISHING ROD

(71) Applicant: GLOBERIDE, Inc., Higashikurume-shi (JP)

(72) Inventor: Toshiki MORIOKA, Higashikurume-shi (JP)

(73) Assignee: GLOBERIDE, Inc., Higashikurume-shi (JP)

(21) Appl. No.: 19/359,101

(22) Filed: Oct. 15, 2025

(30) Foreign Application Priority Data
Jan. 30, 2025 (JP) 2025-014075

(51) Int. Cl. A01K 87/06

(52) U.S. Cl. CPC A01K 87/06

(57) ABSTRACT

A fishing rod reel seat according to one embodiment of the present invention comprises: a reel seat main body in which a reel leg placing portion and a fixed hood into which one end of the reel leg is inserted are formed; and a moving hood guided to an outer surface of the reel seat main body and configured to be movable along an axial direction of the reel seat main body, in which the moving hood comprises: a hood portion into which the other end of the reel leg is inserted; and an extension portion, and in the extension portion, a stepped portion is formed on an inner surface of the extension portion at a position in a range of 3 mm or more from an end of the extension portion on the fixed hood side in a direction opposite to the fixed hood.

### CROSS-REFERENCE TO RELATED APPLICATION

This application claims priority under 35 U.S.C. § 119 to Japanese Patent Application No. 2025-014075 filed on January 30, 2025 in the Japanese Patent Office, the entire contents of each hereby incorporated by reference.

### BACKGROUND OF THE INVENTION

### 1. TECHNICAL FIELD

The present invention relates to a fishing rod reel seat, and a fishing rod comprising the fishing rod reel seat.

### 2. DESCRIPTION OF THE RELATED ART

In the related art, various devices for fixing a fishing rod attachment leg of a fishing reel to a fishing rod are known. For example, such a reel fixing device includes a reel seat main body provided with a placement portion on which a fishing rod attachment leg of a fishing reel is placed. A fixed hood for fixing one end of the fishing rod attachment leg is provided at one end of the reel seat main body. A moving hood is attached to the other end of the reel seat main body so as to be movable facing the fixed hood.

JP 5984299 B2 discloses a fishing rod reel seat including a cylindrical reel seat main body externally mounted on a rod main body, and a cylindrical movable hood body in which a hood portion for holding an end of a reel leg is formed, the cylindrical movable hood body externally mounted on the reel seat main body so as to be slidable in a rod axis direction, in which a concave relief portion is formed at a position on an outer peripheral surface of the reel seat main body where a portion on an opposite side of a hood portion in an opening edge portion on a reel leg insertion side of the movable hood body faces in a reel attached state, and the concave relief portion extends on both sides in a circumferential direction along an opening edge portion on a reel leg insertion side of the movable hood body around a position facing a back surface side top portion facing a circumferential center portion of the hood portion at 180 degrees in the opening edge portion on the reel leg insertion side of the movable hood body, and is gradually shallower as the concave relief portion is away from the position facing the back surface side top portion in the circumferential direction.

### SUMMARY OF THE INVENTION

However, a reel seat disclosed in JP 5984299 B2 has a problem that a step difference between the reel seat main body and the moving hood becomes large due to a relief portion.

The present invention has been made in view of the above circumstances, and an object of the present invention is to provide a fishing rod reel seat capable of effectively preventing damage to an end surface of a moving hood at the time of fixing a reel leg of a fishing reel and improving durability while suppressing a step difference between the reel seat main body and the moving hood, and a fishing rod comprising the fishing rod reel seat. Other objects of the present invention will become apparent upon reference to the entirety of the present specification.

A fishing rod reel seat according to one embodiment of the present invention is a fishing rod reel seat comprising: a reel seat main body in which a reel leg placing portion on which a reel leg is placed and a fixed hood into which one end of the reel leg is inserted are formed; a moving hood guided to an outer surface of the reel seat main body and configured to be movable along an axial direction of the reel seat main body, in which the moving hood comprises: a hood portion into which the other end of the reel leg is inserted, and an extension portion extending from the hood portion toward the fixed hood, and

in the extension portion, a stepped portion is formed on an inner surface of the extension portion at a position in a range of 3 mm or more from an end of the extension portion on the fixed hood side in a direction opposite to the fixed hood.

In the fishing rod reel seat according to one embodiment of the present invention, the height of the stepped portion formed on the inner surface of the extension portion is 0.2 mm or more.

In the fishing rod reel seat according to one embodiment of the present invention, the extension portion is formed in a substantially arc shape or a substantially semicircular shape as viewed in a cross section perpendicular to an extending direction of the extension portion.

In the fishing rod reel seat according to one embodiment of the present invention, the stepped portion is formed in a substantially arc shape or a substantially semicircular shape when the extension portion is viewed from the fixed hood side in an extending direction of the extension portion.

In the fishing rod reel seat according to one embodiment of the present invention, an end of the hood portion is formed in an R shape in a direction opposite to the fixed hood.

In the fishing rod reel seat according to one embodiment of the present invention, the extension portion is formed in a semi-cylindrical shape, a pair of left and right convex portions extending in the extending direction are formed on an inner surface of the extension portion, and a pair of left and right groove portions engaged with the pair of left and right convex portions are formed on an outer surface of the reel seat main body in order to be able to guide the pair of left and right convex portions, and a center line of the pair of left and right groove portions is offset in a direction opposite to the hood portion with respect to a center line of the pair of left and right convex portions as viewed in a vertical direction of the reel seat main body.

In the fishing rod reel seat according to one embodiment of the present invention, the extension portion is formed to extend toward the fixed hood in a range of 35 mm or less from an end of the hood portion on the fixed hood side.

In the fishing rod reel seat according to one embodiment of the present invention, the stepped portion is formed so as to be positioned closer to the fixed hood than an end of the hood portion on the fixed hood side as viewed in an extending direction of the extension portion.

In the fishing rod reel seat according to one embodiment of the present invention, the extension portion comprises a base portion and a thin portion formed to be thinner than the base portion as viewed in an extending direction of the extension portion, and the stepped portion is formed in a boundary region between the base portion and the thin portion.

In the fishing rod reel seat according to one embodiment of the present invention, the stepped portion comprises a plurality of stepped portions.

A fishing rod reel seat according to one embodiment of the present invention is a fishing rod reel seat comprising: a reel seat main body in which a reel leg placing portion on which a reel leg is placed and a fixed hood into which one end of the reel leg is inserted are formed; a moving hood guided to an outer surface of the reel seat main body and configured to be movable along an axial direction of the reel seat main body, in which the moving hood comprises: a hood portion into which the other end of the reel leg is inserted; and an extension portion extending from the hood portion toward the fixed hood, and a stepped portion that comes into contact with an outer surface of the reel seat main body when the reel leg is inserted and fixed is formed on an inner surface of the extension portion at a position other than an end of the extension portion on the fixed hood side.

A fishing rod according to one embodiment of the present invention is provided with any one of the fishing rod reel seats described above and a rod body.

According to the above embodiment, it is possible to provide a fishing rod reel seat capable of effectively preventing damage to an end surface of a moving hood at the time of fixing a reel leg of a fishing reel and improving durability while suppressing a step difference between a reel seat main body and a moving hood, and a fishing rod comprising the fishing rod reel seat.

### BRIEF DESCRIPTION OF THE DRAWINGS

FIG. 1 is a view illustrating a fishing rod according to one embodiment of the present invention;

FIG. 2 is a view illustrating a fishing rod reel seat according to one embodiment of the present invention;

FIG. 3A is a configuration diagram including a partial cross-sectional view (a cross section in a direction from the center of the bottom surface toward the center of the upper surface of the reel seat main body) of a moving hood of a reel seat according to one embodiment of the present invention, and FIG. 3B is a configuration diagram including a cross-sectional view (a cross section perpendicular to the central axis of the reel seat main body) of the moving hood of the reel seat according to one embodiment of the present invention;

FIG. 4A is a top perspective view of a reel seat according to one embodiment of the present invention, FIG. 4B is a top view of the reel seat according to one embodiment of the present invention, FIG. 4C is a side view of the reel seat according to one embodiment of the present invention, and FIG. 4D is a rear view of the reel seat according to one embodiment of the present invention; and

FIG. 5 is a view for explaining an aspect in which the moving hood in the reel seat according to one embodiment of the present invention is guided with respect to the outer peripheral surface of a reel seat main body.

### DETAILED DESCRIPTION

Hereinafter, an embodiment of a fishing rod according to the present invention will be specifically described with reference to the attached drawings. Components common in a plurality of drawings are assigned with the same reference signs throughout the plurality of drawings. It should be noted that each drawing is not necessarily drawn to an accurate scale for the convenience of description.

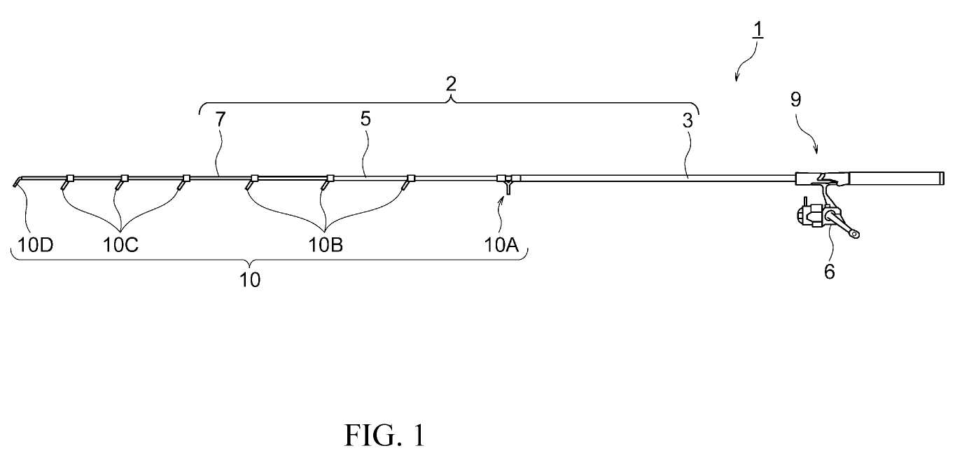

FIG. 1 is a view illustrating one embodiment of a fishing rod according to the present invention. As illustrated in the drawing, a fishing rod 1 according to one embodiment of the present invention comprises a rod body 2, a reel 6 attached to the rod body 2 via a reel seat 9, and a fishing line guide 10 attached to the rod body 2. In the illustrated embodiment, each of the reel seat 9 and the fishing line guide 10 corresponds to an attachment component attached to an outer peripheral surface of the rod body.

The rod body 2 is formed by, for example, connecting a base rod 3, a middle rod 5, a tip rod 7, and the like to each other. These rod bodies are jointed to each other, for example, as an ordinarily jointed type. The base rod 3, the middle rod 5, and the tip rod 7 can be joined to each other by a telescopic type, an inversely jointed type, a socket-and-spigot jointed type, or any other known joining method. The rod body 2 may be constituted by a single rod body.

Each of the base rod 3, the middle rod 5, and the tip rod 7 is formed by, for example, a tubular body made of a fiber-reinforced resin. This tubular body made of the fiber-reinforced resin is produced by winding a fiber-reinforced resin prepreg (prepreg sheet) obtained by impregnating reinforcing fibers with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. In addition, an outer surface of the tubular body is appropriately polished. Each of the rod bodies may be formed in a solid state.

In the illustrated embodiment, the base rod 3, the middle rod 5, and the tip rod 7 comprises a plurality of the fishing line guides 10 (fishing line guides 10A to 10D) for guiding a fishing line fed from the reel 6 attached to the reel seat 9. More specifically, the base rod 3 is provided with the fishing line guide 10A, the middle rod 5 is provided with the fishing line guide 10B, and the tip rod 7 is provided with the fishing line guide 10C. The tip rod 7 comprises a top guide 10D at a front end thereof, but details thereof are omitted.

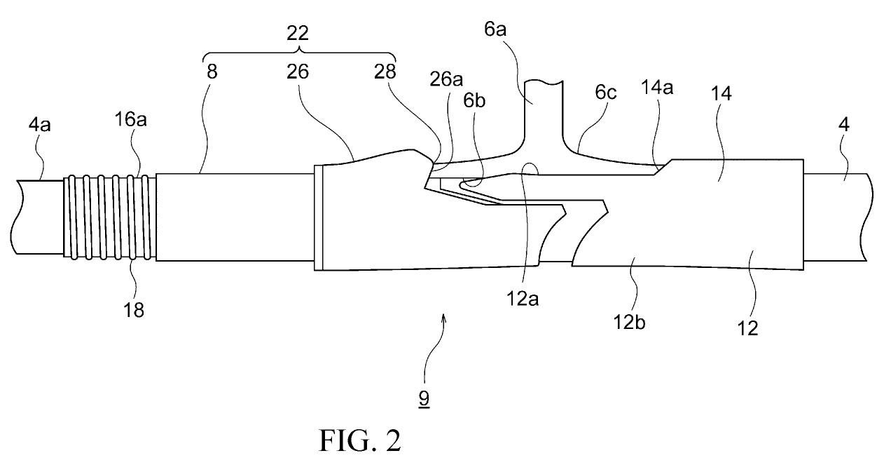

Next, a reel seat main body 12 and a fishing rod reel seat 9 comprising the reel seat main body will be described with reference to FIG. 2. The reel seat main body 12 comprises the reel seat main body 12 having, along its axial direction, a reel leg placing surface (reel leg placing portion) 12a on which a reel leg 6a of the reel 6 for fishing is placed. The reel seat main body 12 is formed in a cylindrical shape or a substantially cylindrical shape as a whole. In addition, the reel seat main body 12 is made of an appropriate material such as a synthetic resin (for example, polyamide-based synthetic fiber, ABS resin, or the like) or metal (for example, SUS, aluminum, titanium, brass, or the like). The reel seat main body 12 can be configured with, for example, a length of 60 to 160 mm, but is not limited thereto.

In addition, the reel seat main body 12 comprises a grip portion 12b that slightly bulges opposite to a reel leg placing surface 12a, and that has a curved outer surface which is made easy to grip by supporting the thenar or the vicinity thereof when gripped with a gripping hand.

The reel leg placing surface 12a of the reel seat main body 12 can be formed flat or substantially flat with a larger curvature than other circumferential portions (for example, the grip portion 12b) adjacent to the reel leg placing surface 12a of the reel seat main body 12, and is formed to extend in the axial direction of the reel seat main body 12 illustrated in FIG. 2. A fixed hood 14 is integrally disposed on one end (rod tip side) of the reel seat main body 12. A part of the reel leg placing surface 12a of the reel seat main body 12 is disposed inside the fixed hood 14.

The reel seat main body 12 is integrally provided with a cylindrical body in which a guide groove is formed at the other end (rod butt side) and a screw portion (male screw portion) 18. In the cylindrical body, a cylindrical portion placing surface 16a is formed continuously with the reel leg placing surface 12a of the reel seat main body 12 or with a slight step difference. In one embodiment of the present invention, a step difference for disposing a back surface holding portion of a reel leg holding portion 28 is formed between the reel leg placing surface (reel leg placing portion) 12a and the cylindrical portion placing surface 16a so that the back surface holding portion of the reel leg holding portion 28, which will be described later, on which a back surface (bottom surface) 6b of the reel leg 6a is placed and the reel leg placing surface 12a are as flush as possible. The cylindrical portion placing surface 16a is also formed continuously with the screw portion (male screw portion) 18. At the other end (rod butt side), a moving hood 22 (also referred to as a floating hood) is attached to the outside of the cylindrical body and the screw portion 18 so as to be movable in the axial direction. Here, the reel seat main body 12 and the moving hood 22, or the reel seat main body 12, the moving hood 22, and a nut 8 may be referred to as the fishing rod reel seat 9, but details are omitted.

As illustrated in FIG. 2, in the fixed hood 14 of the reel seat main body 12, an opening portion 14a that receives one end of the reel leg 6a is opened toward the moving hood 22. The opening portion 14a of the fixed hood 14 is formed such that the height of an inner surface is gradually decreased toward a front of the reel seat main body 12. When one end of the reel leg 6a is received in the opening portion 14a and the one end of the reel leg 6a is pressed by the opening portion 14a, the reel leg 6a is biased (pressed) toward the reel leg placing surface 12a disposed in the fixed hood 14.

Note that the fixed hood 14 is not limited to being disposed integrally with the reel seat main body 12, and may be formed of a metal or a hard synthetic resin to have a structure separate from the reel seat main body 12 and firmly fixed to the reel seat main body 12. In a case of being formed of metal, it is preferable to dispose a resin member at a portion abutting on the reel leg 6a of the reel 6 to prevent damage to each member due to the contact between metals.

The moving hood 22 is formed in a sleeve shape penetrating an axial hole through which the screw portion (male screw portion) 18 of the reel seat main body 12 is inserted, and comprises a hood portion (hood main body) 26, and the reel leg holding portion 28 fixed inside the hood portion (hood main body) 26. The nut 8 is rotatably connected to a rear portion (rod butt side) of the hood portion (hood main body) 26 of the moving hood 22, and an extension portion, which will be described in detail later, is formed in a front portion (rod tip side) of the hood portion (hood main body) 26. The nut 8 is formed of, for example, synthetic resin, metal, polyamide synthetic fiber, ABS resin, aluminum, brass, or the like, the hood portion (hood main body) 26 is formed of, for example, metal (SUS, brass) or the like, and the reel leg holding portion 28 is formed of, for example, polyamide-based synthetic fiber or the like.

In the nut 8, a female screw portion (not illustrated) screwed to the screw portion (male screw portion) 18 is formed on the inner peripheral side, and the outer peripheral side is formed to be less slippery and to be easily rotated. A front end of the nut 8 is connected (locked) to a rear end of the hood portion (hood main body) 26 in a state of being relatively rotatable and prevented from coming off. More specifically, the nut 8 comprises a locking portion (not illustrated), is locked by a locked portion (not illustrated) at the rear end of the hood portion (hood main body) 26, and can be configured to be prevented from coming off while being relatively rotatable. Note that the connection structure between the nut 8 and the hood portion (hood main body) 26 is variously considered, and is not limited to a specific aspect.

The nut 8 is screwed with the screw portion (male screw portion) 18 of the reel seat main body 12 and rotatably disposed. As described above, since the hood portion (hood main body) 26 is connected to the nut 8, when the nut 8 is rotated in the positive direction with respect to the screw portion (male screw portion) 18, the nut 8 approaches the fixed hood 14 and the hood portion (hood main body) 26 of the moving hood 22 approaches the fixed hood 14. On the other hand, when the nut 8 is rotated in a reverse direction with respect to the screw portion (male screw portion) 18, the nut 8 is moved away from the fixed hood 14 and the hood portion (hood main body) 26 of the moving hood 22 is moved away from the fixed hood 14.

The hood portion (hood main body) 26 moved in the axial direction of the reel seat main body 12 by the rotation of the nut 8 comprises an opening portion 26a that is opened on the front side and the inner peripheral side and is fixed in a state where the reel leg holding portion 28 for receiving the rear end of the reel leg 6a of the reel 6 for fishing is disposed. The opening portion 26a of the hood portion (hood main body) 26 faces the opening portion 14a of the fixed hood 14 when the moving hood 22 is attached to the screw portion (male screw portion) 18 of the reel seat main body 12. Contrary to the opening portion 14a of the fixed hood 14, the opening portion 26a of the hood portion (hood main body) 26 is formed such that the height of the inner surface is gradually decreased toward the rear.

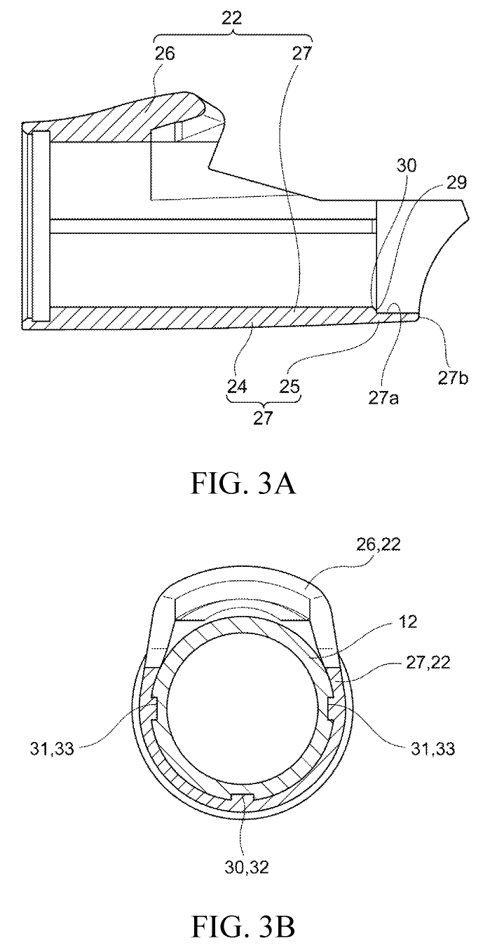

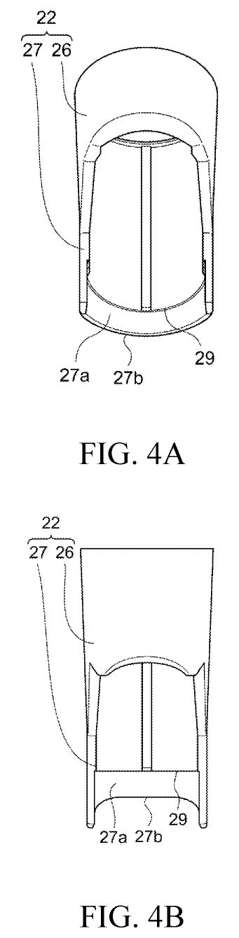

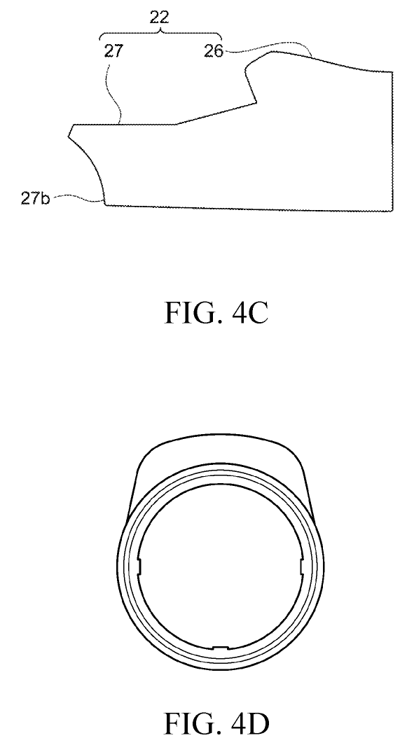

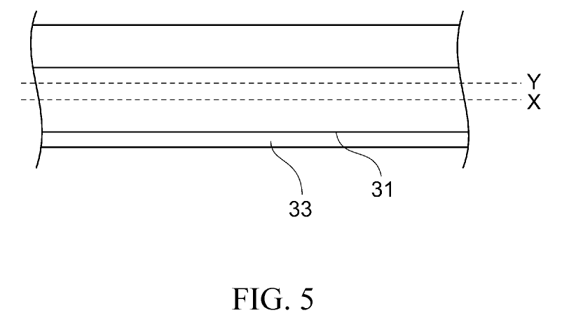

Next, the reel seat 9 according to one embodiment of the present invention will be further described in detail with reference to FIGS. 2, 3A to 3B, 4A to 4D, and 5. FIG. 3A is a configuration diagram comprising a partial cross-sectional view (a cross section in a direction from the center of the bottom surface toward the center of the upper surface of the reel seat main body) of the moving hood 22 of the reel seat 9 according to one embodiment of the present invention, and FIG. 3B is a configuration diagram comprising a cross-sectional view (a cross section perpendicular to the central axis of the reel seat main body) of the moving hood 22 of the reel seat 9 according to one embodiment of the present invention. FIG. 4A is a top perspective view of the reel seat 9 according to one embodiment of the present invention, FIG. 4B is a top view of the reel seat 9 according to one embodiment of the present invention, FIG. 4C is a side view of the reel seat 9 according to one embodiment of the present invention, and FIG. 4D is a rear view of the reel seat 9 according to one embodiment of the present invention. FIG. 5 is a view for describing an aspect in which the moving hood 22 in the reel seat 9 according to one embodiment of the present invention is guided with respect to the outer peripheral surface of the reel seat main body 12.

As illustrated in FIGS. 2, 3A to 3B, and 4A ti 4D, the fishing rod reel seat 9 according to one embodiment of the present invention comprises the reel seat main body 12 in which a reel leg placing portion 12a on which a reel leg 6a is placed and a fixed hood 14 into which one end of the reel leg 6a is inserted are formed, and the moving hood 22 that is guided to an outer surface of the reel seat main body 12 and configured to be movable along an axial direction of the reel seat main body 12, in which the moving hood 22 comprises a hood portion 26 into which the other end of the reel leg 6a is inserted and an extension portion 27 extending from the hood portion 26 toward the fixed hood 14, and a stepped portion (step portion) that comes into contact with an outer surface of the reel seat main body 12 when the reel leg 6a is inserted and fixed is formed on an inner surface 27a of the extension portion 27 at a position other than an end 27b of the extension portion 27 on the fixed hood 14 side.

According to the fishing rod reel seat 9 according to one embodiment of the present invention, when the reel leg of the fishing reel is fixed, the stepped portion formed on the inner surface of the extension portion in front of the end surface (end) of the moving hood is configured to be in contact with the outer surface of the reel seat main body while suppressing the step difference between the reel seat main body and the moving hood, so that it is possible to provide the fishing rod reel seat capable of effectively preventing damage to the end surface (end) of the moving hood and improving durability.

The fishing rod reel seat 9 according to one embodiment of the present invention comprises: the reel seat main body 12 in which the reel leg placing portion 12a on which the reel leg 6a is placed and the fixed hood 14 into which one end of the reel leg 6a is inserted are formed; and the moving hood 22 guided to an outer surface of the reel seat main body 12 and configured to be movable along an axial direction of the reel seat main body 12, in which the moving hood 22 comprises: the hood portion 26 into which the other end of the reel leg 6a is inserted; and the extension portion 27 extending from the hood portion 26 toward the fixed hood 14, and at the extension portion 27, the stepped portion 29 on an inner surface 27a of the extension portion 27 is formed at a position in a range of 3 mm or more from the end 27b of the extension portion 27 on a side of the fixed hood 14 to a direction opposite to the fixed hood 14, more preferably, a range of 3 mm or more and 30 mm or less.

According to the fishing rod reel seat 9 according to one embodiment of the present invention, when the reel leg of the fishing reel is fixed, the stepped portion formed on the inner surface of the extension portion in front of the end surface (end) of the moving hood is configured to be in contact with the outer surface of the reel seat main body while suppressing the step difference between the reel seat main body and the moving hood, so that it is possible to provide the fishing rod reel seat capable of effectively preventing damage to the end surface (end) of the moving hood and improving durability.

In the fishing rod reel seat 9 according to one embodiment of the present invention, the height (radially inside the extension portion 27) of the stepped portion 29 formed on the inner surface 27a of the extension portion 27 is 0.2 mm or more. In this manner, it is possible to avoid stress concentration on the end of the moving hood due to the inclination of the moving hood when the fishing reel is mounted. Here, as illustrated in FIGS. 3A to 3B and 4A to 4D, the stepped portion 29 is formed so as to extend along the circumferential direction or substantially the circumferential direction of the extension portion 27, but a convex portion 30 of a bottom portion extending in the extending direction of the extension portion 27 is formed in a central region thereof, and the convex portion 30 of the bottom portion is formed on the outer peripheral surface of the reel seat main body 12 together with a pair of left and right convex portions 31 to be described later, and the moving hood 22 is configured to be able to be guided with respect to the reel seat main body 12 so that the convex portion 30 of the bottom portion and a pair of left and right convex portions 31 are engaged with a groove portion 32 of the bottom portion and a pair of left and right groove portions 33, respectively. In this manner, the moving hood 22 is configured to be able to be guided with respect to the reel seat main body 12, and when the reel leg of the fishing reel is fixed, the stepped portion formed on the inner surface of the extension portion in front of the end surface (end) of the moving hood is configured to be in contact with the outer surface of the reel seat main body, so that it is possible to provide the fishing rod reel seat capable of effectively preventing damage to the end surface (end) of the moving hood and improving durability.

In addition, as illustrated in FIGS. 4A to 4D, in the fishing rod reel seat 9 according to one embodiment of the present invention, the extension portion 27 is formed in a substantially arc shape or a substantially semicircular shape as viewed in a cross section perpendicular to the extending direction of the extension portion 27. In this manner, not only the extension portion can be more smoothly guided along the reel seat main body, but also a space for gripping the outer peripheral surface of the extension portion can be secured.

In the fishing rod reel seat 9 according to one embodiment of the present invention, the stepped portion 29 is formed in a substantially arc shape or a substantially semicircular shape when the extension portion 27 is viewed from the fixed hood 14 side in the extending direction of the extension portion 27. In this manner, when the reel leg of the fishing reel is fixed, stress concentration at a position where the stepped portion formed on the inner surface of the extension portion in front of the end surface (end) of the moving hood comes into contact with the outer surface of the reel seat main body can be further reduced, so that damage to the end surface (end) of the moving hood can be more effectively prevented, and durability can be improved.

As illustrated in FIG. 4B, in the fishing rod reel seat 9 according to one embodiment of the present invention, an end (end surface) of the hood portion 26 is formed in an R shape (substantially arc shape) toward a direction opposite to the fixed hood 14. In this manner, the end of the hood portion 26 can be configured such that the stepped portion formed on the inner surface of the extension portion in front of the end (end surface) of the hood portion of the moving hood comes into contact with the outer surface of the reel seat main body when the reel leg of the fishing reel is fixed, and thus it is possible to provide the fishing rod reel seat capable of effectively preventing damage to the end surface (end) of the moving hood and improving durability.

As illustrated in FIGS. 3A to 3B and 5, in the fishing rod reel seat 9 according to one embodiment of the present invention, the extension portion 27 is formed in a semi-cylindrical shape or a substantially semi-cylindrical shape, the inner surface 27a of the extension portion 27 is formed with the pair of left and right convex portions 31 extending in the extending direction of the extension portion 27, the outer surface of the reel seat main body 12 is formed with the pair of left and right groove portions 33 engaged with the pair of left and right convex portions 31 (into which the pair of left and right convex portions 31 is inserted) so as to be able to guide the pair of left and right convex portions 31, and a center line (a center line Y illustrated in FIG. 5) of the pair of left and right groove portions 33 is offset in a direction opposite to the hood portion 26 (that is, the opening portion 26a of the hood portion 26) with respect to a center line (a center line X illustrated in FIG. 5) of the pair of left and right convex portions 31 as viewed in a vertical direction (a direction from the bottom to the top of the reel seat main body or its opposite direction) of the reel seat main body 12. In this manner, the moving hood 22 is inclined in the upper left direction in FIG. 3A when the reel leg 6a is attached. However, by shifting the center line of the pair of left and right convex portions 31 to the hood portion 26 (that is, the opening portion 26a of the hood portion 26) side with respect to the center line of the pair of left and right groove portions 33, the side walls of the pair of left and right convex portions 31 are supported by being in contact with the inner walls (side walls) of the pair of left and right groove portions 33 before the thin portion of the end (end surface) of the moving hood comes into contact with the reel seat main body. Therefore, it is possible to reliably reduce cracking of the thin portion of the end (end surface) of the moving hood due to contact of the thin portion of the end portion (end surface) of the moving hood with the reel seat main body.

In the fishing rod reel seat 9 according to one embodiment of the present invention, the extension portion 27 is formed to extend toward the fixed hood 14 side in a range of 35 mm or less, more preferably in a range of 5 mm or more and 35 mm or less, and still more preferably in a range of 20 mm or more and 35 mm or less from an end of the hood portion 26 on the fixed hood 14 side.

In addition, as illustrated in FIG. 3A, in the fishing rod reel seat 9 according to one embodiment of the present invention, the stepped portion 29 is formed so as to be positioned closer to the fixed hood than an end of the hood portion 26 on the fixed hood 14 side as viewed in the extending direction of the extension portion 27. In this manner, it is possible to more intentionally provide (In other words, it is difficult to intentionally set the abutting position to a position other than the stepped portion.) the abutting position due to the inclination of the moving hood at the time of attaching the fishing reel on the stepped portion.

In the fishing rod reel seat 9 according to one embodiment of the present invention, the extension portion 27 comprises a base portion 24 and a thin portion 25 formed to be thinner than the base portion 24 as viewed in the extending direction of the extension portion 27, and the stepped portion 29 is formed in a boundary region between the base portion 24 and the thin portion 25. In this manner, when the reel leg of the fishing reel is fixed, the stepped portion formed on the inner surface of the extension portion in front of the end surface (end) of the moving hood is configured to come into contact with the outer surface of the reel seat main body, so that it is possible to effectively prevent damage to the thin portion of the end surface (end) of the moving hood and to improve durability.

In the fishing rod reel seat 9 according to one embodiment of the present invention, the stepped portion 29 comprises a plurality of stepped portions. In this manner, it is possible to further disperse the stress when the moving hood abuts on the reel seat.

A fishing rod according to one embodiment of the present invention is provided with any one of the fishing rod reel seats described above and a rod body. In this manner, it is possible to provide the fishing rod comprising the fishing rod reel seat capable of effectively preventing damage to an end surface of the moving hood at the time of fixing a reel leg of a fishing reel and improving durability while suppressing a step difference between the reel seat main body and the moving hood.

The dimension, material, and disposition of each component described in the present specification are not limited to those explicitly described in the embodiments, and each component can be modified to have any dimension, material, and disposition that are within the scope of the present invention. In addition, components not explicitly described in the present specification can also be added to the described embodiments, or some of the components described in the embodiments can be omitted.

### REFERENCE SIGNS LIST

1 Fishing rod

2 Rod body

3 Base rod

5 Middle rod

6 Reel

6a Reel leg

7 Tip rod

8 Nut

9 Fishing rod reel seat

10 Fishing line guide

12 Reel seat main body

12a Reel leg placing surface

14 Fixed hood

16a Cylindrical portion placing surface

18 Screw portion (male screw portion)

22 Moving hood

24 Base portion

25 Thin portion

26 Hood portion (hood main body)

27 Extension portion

27a Inner surface

27b End

28 Reel leg holding portion

29 Stepped portion (step portion)

30 Convex portion of bottom portion

31 Pair of left and right convex portions

32 Groove portion of bottom portion

33 Pair of left and right groove portions

What is claimed is:

1. A fishing rod reel seat comprising: a reel seat main body in which a reel leg placing portion on which a reel leg is placed and a fixed hood into which one end of the reel leg is inserted are formed; a moving hood guided to an outer surface of the reel seat main body and configured to be movable along an axial direction of the reel seat main body,
wherein the moving hood comprises: a hood portion into which the other end of the reel leg is inserted, and an extension portion extending from the hood portion toward the fixed hood, and
in the extension portion, a stepped portion is formed on an inner surface of the extension portion at a position in a range of 3 mm or more from an end of the extension portion on the fixed hood side in a direction opposite to the fixed hood.

2. The fishing rod reel seat according to claim 1, wherein a height of the stepped portion formed on the inner surface of the extension portion is 0.2 mm or more.

3. The fishing rod reel seat according to claim 1, wherein the extension portion is formed in a substantially arc shape or a substantially semicircular shape as viewed in a cross section perpendicular to an extending direction of the extension portion.

4. The fishing rod reel seat according to claim 1, wherein the stepped portion is formed in a substantially arc shape or a substantially semicircular shape when the extension portion is viewed from the fixed hood side in an extending direction of the extension portion.

5. The fishing rod reel seat according to claim 1, wherein an end of the hood portion is formed in an R shape in a direction opposite to the fixed hood.

6. The fishing rod reel seat according to claim 1, wherein the extension portion is formed in a semi-cylindrical shape, a pair of left and right convex portions extending in the extending direction are formed on the inner surface of the extension portion, and a pair of left and right groove portions engaged with the pair of left and right convex portions are formed on an outer surface of the reel seat main body in order to be able to guide the pair of left and right convex portions, and
a center line of the pair of left and right groove portions is offset in a direction opposite to the hood portion with respect to a center line of the pair of left and right convex portions as viewed in a vertical direction of the reel seat main body.

7. The fishing rod reel seat according to claim 1, wherein the extension portion is formed to extend toward the fixed hood in a range of 35 mm or less from an end of the hood portion on the fixed hood side.

8. The fishing rod reel seat according to claim 1, wherein the stepped portion is formed so as to be positioned closer to the fixed hood than an end of the hood portion on the fixed hood side as viewed in an extending direction of the extension portion.

9. The fishing rod reel seat according to claim 1, wherein the extension portion comprises a base portion and a thin portion formed to be thinner than the base portion when viewed in an extending direction of the extension portion, and the stepped portion is formed in a boundary region between the base portion and the thin portion.

10. The fishing rod reel seat according to claim 1, wherein the stepped portion comprises a plurality of stepped portions.

11. A fishing rod reel seat comprising: a reel seat main body in which a reel leg placement portion on which a reel leg is placed and a fixed hood into which one end of the reel leg is inserted are formed; and a moving hood guided to an outer surface of the reel seat main body and configured to be movable along an axial direction of the reel seat main body,
wherein the moving hood comprises: a hood portion into which the other end of the reel leg is inserted; and an extension portion extending from the hood portion toward the fixed hood, and
a stepped portion that comes into contact with an outer surface of the reel seat main body when the reel leg is inserted and fixed is formed on an inner surface of the extension portion at a position other than an end of the extension portion on the fixed hood side.

12. A fishing rod comprising: the fishing rod reel seat according to claim 1; and a rod body.
